(19) United States
(12) Patent Application Publication
(10) Pub. No.: US 2023/0044773 A1
(43) Pub. Date: Feb. 9, 2023

(54) RECOMMENDATION OF RECIPES TO A USER OF AN ONLINE CONCIERGE SYSTEM BASED ON ITEMS INCLUDED IN AN ORDER BY THE USER

(71) Applicant: Maplebear Inc.(dba Instacart), San Francisco, CA (US)

(72) Inventors: Omar Alonso, Redwood City, CA (US); Wei Peng, San Francisco, CA (US)

(21) Appl. No.: 17/396,290

(22) Filed: Aug. 6, 2021

(51) Int. Cl. G06Q 30/06

(52) U.S. Cl. CPC G06Q 30/0631; G06Q 30/0633

(57) ABSTRACT

An online concierge shopping system identifies recipes to users to encourage them to include items from the recipes in orders. The online concierge system generates a recipe vector for each recipe based on items included in a recipe. A dimension of a recipe vector identifies an item included in a corresponding recipe and may include an importance score of the item to the recipe. The importance score of an item to a recipe is based on a term frequency of the item in the recipe and an inverse document frequency of the item across multiple recipes. The online concierge system determines overlap between items in recipe vectors an order vector generated from items included in an order from a user and selects a recipe for the user based on overlapping items in the recipe vector and in the order vector.

### BACKGROUND

This disclosure relates generally to ordering one or more items through an online concierge system, and more specifically to identifying one or more recipes including one or more items to a user of an online concierge system.

In current online concierge systems, shoppers (or “pickers”) fulfill orders at a physical warehouse, such as a retailer, on behalf of customers as part of an online shopping concierge service. An online concierge system provides an interface to a customer identifying items offered by a physical warehouse and receives selections of one or more items for an order from the customer. In current online concierge systems, the shoppers may be sent to various warehouses with instructions to fulfill orders for items, and the shoppers then find the items included in the customer order in a warehouse.

To simplify selection of items for inclusion in an order, an online concierge system may maintain various recipes, with recipe including one or more items. A user of the online concierge system may review a recipe and add items from the recipe to an order through the online concierge system, simplifying selection of items for inclusion in an order. A conventional online concierge system allows a user to browse recipes obtained by the online concierge system. While an online concierge system may organize recipes into different sections to simplify user browsing or selection of recipes, as numbers of recipes in different sections increases, an amount of time for a user to select a particular recipe or to identify a particular recipe of interest increases. This increased time for browsing may discourage a user from subsequent interaction with the online concierge system.

### SUMMARY

An online concierge system obtains recipes from one or more sources. Example sources include a warehouse or a third party system (e.g., a website) exchanging information with the online concierge system. Each recipe includes one or more items, or a plurality of items. A recipe may include a quantity corresponding to each item included in the recipe. Additionally, a recipe may include instructions for combining items included in the recipe. In various embodiments, a recipe includes a title, a description, identifiers of one or more items, and quantities for each of the one or more items included in the recipe.

For each recipe, the online concierge system generates a recipe vector. To generate the recipe vector for a recipe, the online concierge system identifies each item included in the recipe, so a dimension of the recipe vector corresponds to an item included in the recipe. Hence, different dimensions of a recipe vector correspond to different items included in the recipe.

In various embodiments, the recipe vector also includes an importance score for each item included in the recipe, so each dimension of the recipe vector identifies an item included in the item and the importance score for the item. For example, the importance score for an item is a term frequency-inverse document frequency (TF-IDF) value for the item in various embodiments. In various embodiments, the online concierge system determines a product of a term frequency of the item in a recipe and an inverse document frequency of the term across a set of recipes. However, the importance score may be determined based on any suitable method or methods for determining an importance of a term to a document; for example, the importance score is determined from any suitable measure of a frequency of a term occurring in a recipe relative to a frequency of the term occurring across a set of recipes. In some embodiments, the set of recipes comprises all recipes obtained by the online concierge system. Higher importance scores indicate an item has higher relevance to a recipe, while lower importance scores indicate the item has a lower relevance to the recipe. In various embodiments, the online concierge system normalizes the importance scores for items so an importance score has a value between 0 and 1.

In some embodiments, the online concierge system uses recipe vectors for different recipes to determine similarities between different recipes. The similarity between a pair of recipes is based on an amount of items common to each recipe. For example, the similarity between a recipe and an additional recipe is a ratio of items included in both the recipe and the additional recipe to a total number of items included in the recipe and the additional recipe. Hence, the similarity between a recipe and additional recipe is a Jaccard similarity between the recipe vector for the recipe and the additional recipe vector for the additional recipe. In some embodiments, when determining the similarity between a recipe and an additional recipe, the online concierge system accounts for importance scores of items included in the recipe and included in the additional recipe. For example, the similarity between the recipe and the additional recipe is a weighted Jaccard similarity that sums importance scores for items in the recipe and in the additional recipe. As an example, for items included in both the recipe and in the additional recipe, the online concierge system selects a minimum of the importance score of an item to the recipe and the importance score of the item to the additional recipe and sums the selected importance scores for the items included in both the recipe and in the additional recipe. Similarly, the online concierge system selects a maximum importance score of items to the recipe and to the additional recipe and sums the maximum importance score of items included in the recipe or included in the additional recipe. The online concierge system determines the similarity of the recipe to the additional recipe by dividing the sum of the selected importance scores for the items included in both tie recipe and the additional recipe by the sum of the maximum importance scores for each item to one of the recipe or to the additional recipe. A higher similarity between a recipe and an additional recipe indicates the recipe and the additional recipe have a larger number of common items, while lower similarity between the recipe and the additional recipe indicates the recipe and the additional recipe have fewer common items.

In other embodiments, the similarity between a recipe and an additional recipe is based on a distance between the recipe and the additional recipe, with smaller distances between a recipe vector of the recipe and an additional recipe of the additional recipe indicating a higher similarity between the recipe and the additional recipe. The online concierge system may determine the distance between a recipe vector and an additional recipe vector using any suitable method, such as cosine similarity, Euclidean distance, or any other suitable method. Hence, the similarity between a pair of recipes may be based on a distance between recipe vectors corresponding to each of the recipes in various embodiments.

In various embodiments, the online concierge system uses similarities between recipes to recommend one or more additional recipes to a user. For example, the user selects a recipe from the online concierge system to view on a client device, such as through a customer mobile application executing on the client device. The online concierge system retrieves a recipe vector for the selected recipe and determines similarities between the recipe vector for the selected recipe and recipe vectors for each recipe of a set. Based on the determined similarities, the online concierge system identifies one or more recipes of the set and displays information describing the identified one or more recipes to the user via the client device. For example, the online concierge system identifies recipes of the set having recipe vectors with at least a threshold similarity to the recipe vector of the selected recipe. As another example, the online concierge system ranks recipes of the set based on their similarities to the recipe vector of the selected recipe and identifies recipes of the set having at least a threshold position in the ranking.

When the online concierge system receives an order from a user, the online concierge system receives selections of items for inclusion in the order from the user. The online concierge system generates an order vector for the order based on items included in the order. In various embodiments, the order vector includes different dimensions that each correspond to a different item included in the order. In some embodiments, when generating the order vector, the online concierge system retrieves one or more prior orders received from the user and generates the order vector based on items included in the received order and included in the one or more prior orders, allowing the online concierge system to account for items the user has previously purchased via the online concierge system when generating the order vector. In some embodiments, the online concierge system retrieves prior orders received within a threshold amount of time from a time when the order was received, and generates the order vector based on items included in the received order and included in the one or more prior orders; hence, the order vector includes different dimensions each corresponding to an item included in the received order or included in one or more of the retrieved prior orders.

The online concierge system determines similarities between the order vector and each of a set of recipe vectors. The similarity between the order vector and a recipe vector is based on an amount of items common to each recipe. For example, the similarity between the order vector and a recipe vector is a ratio of items included in both the order vector and in the recipe vector to a total number of items included in the order vector and included in the recipe vector. Hence, the similarity is a Jaccard similarity between the order vector and the recipe vector in some embodiments. Alternatively, the similarity between the order vector and the recipe vector is a percentage of items included in the recipe vector that are included in the order vector. However, in other embodiments, the online concierge system determines a similarity between an order vector and a recipe vector using any suitable metric. In various embodiments, a higher similarity between the order vector and the recipe vector corresponds to a greater amount of items included in the recipe vector that are included in the order vector. The similarity accounts for measures of importance of items in the recipe vector in various embodiments. For example, the similarity weights items included in the recipe vector that are included in the order vector by their corresponding importance scores and determines the similarity of the recipe vector to the order vector by combining the weighted items included in the recipe vector; hence, items with higher importance values in a recipe vector being included in the order vector increase the similarity of the order vector to the recipe vector.

In some embodiments, when determining similarity between the order vector and a recipe vector, the online concierge system accounts for a quantity of an item included in the order and a quantity of the item specified by a recipe corresponding to the recipe vector. For a specific item included in a recipe, the online concierge system retrieves a quantity of the specific item specified by the recipe. If the specific item is not included in the order received from the user but was included in one or more prior orders received from the user that the online concierge system retrieved, the online concierge system determines a quantity of the specific item included in one or more prior orders from the user retrieved by the online concierge system. From one or more characteristics of the specific item, a timing of the prior order from the user including the specific item, a timing of the received order, and the quantity of the specific item included in the prior order, the online concierge system generates a predicted remaining quantity of the specific item equaling or exceeding the quantity of the specific item specified by the recipe. The online concierge system compares the predicted remaining quantity of the specific item to the quantity of the specific item included in the recipe. In response to the predicted remaining quantity of the specific item being less than the quantity of the specific item included in the recipe, the online concierge system removes the specific item from the order vector and determines similarity between the order vector with the specific item removed and a recipe vector. This allows the online concierge system to account for the user's consumption of the specific item included in a prior order over time when determining similarity between items included in an order vector and items included in a recipe. However, if the predicted remaining quantity of the specific item equals or exceeds the quantity of the specific item included in the recipe, the online concierge system determines similarity between the order vector including the specific item and the recipe vector.

Based on the similarities between the order vector and each of the set of recipe vectors, the online concierge system transmits one or more recommendations to a client device of the user for display. In various embodiments, the recommendations are displayed through a customer mobile application displayed to the user via a client device. For example, the online concierge system ranks recipe vectors based on their similarities to the order vector and selects recipes having at least a threshold position in the ranking or selects a recipe having a highest position in the ranking. A recommendation transmitted to the client device of the user includes an identifier of a selected recipe, such as a name of the selected recipe. In some embodiments, the recommendation also identifies one or more items included in the selected recipe that are not included in the received order and were not included in the one or more prior orders retrieved by the online concierge system. Hence, a recommendation may include a name or a description of a selected recipe and a name or a description of one or more items included in the selected recipe that are not included in the order vector form the received order and the one or more prior orders retrieved by the online concierge system. In some embodiments, the recommendation includes an interface element that, when selected by the user, includes items included in the selected recipe that are not included in the order vector from the received order and the one or more prior orders retrieved by the online concierge system, streamlining completion of the received order to include items for the selected recipe. Identifying items in the recommendation that are not included in the received order based on similarities between the order vector and one or more recipe vectors allows the online concierge system to organize items so that items more likely to be relevant to the user or included in an order are more readily accessible to the user. For example, displaying recommendations including items from a recipe selected from similarity of its recipe vector to the order vector and including an interface element for including the one or more items in the order allows the online concierge system to more prominently identify items for completing the selected recipe via an interface and allows the user to more easily select tie identified items from the recommendation rather than by providing search terms or navigating through product interfaces, simplifying one or more order generation interfaces provided by the online concierge system.

### BRIEF DESCRIPTION OF THE DRAWINGS

FIG. 1 illustrates an environment of an online shopping concierge service, according to one embodiment.

FIG. 2 is a diagram of an online shopping concierge system, according to one embodiment.

FIG. 3A is a diagram of a customer mobile application (CMA), according to one embodiment.

FIG. 3B is a diagram of a shopper mobile application (SMA), according to one embodiment.

FIG. 4 is a flowchart of a method for an online concierge system to select one or more recipes for identification to a user, according to one embodiment.

FIG. 5 is a process flow diagram of a method for an online concierge system to select one or more recipes for identification to a user, according to one embodiment.

The figures depict embodiments of the present disclosure for purposes of illustration only. One skilled in the art will readily recognize from the following description that alternative embodiments of the structures and methods illustrated herein may be employed without departing from the principles, or benefits touted, of the disclosure described herein.

### DETAILED DESCRIPTION

### System Overview

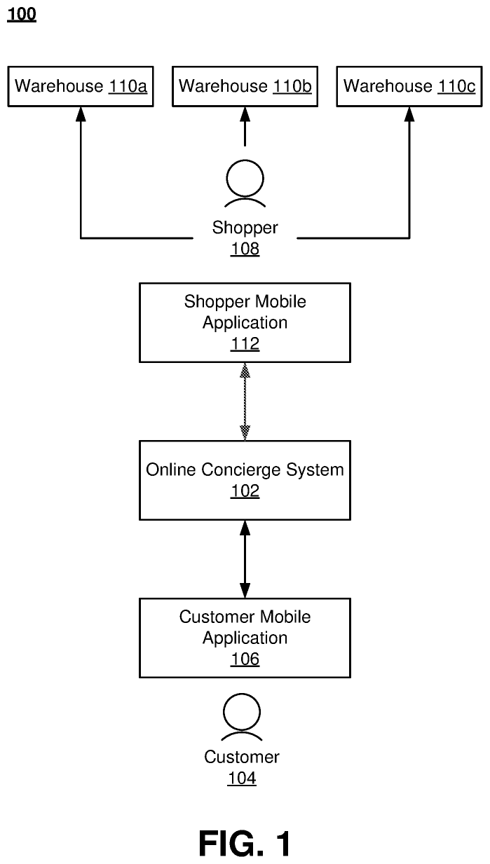

FIG. 1 illustrates an environment 100 of an online platform, according to one embodiment. The figures use like reference numerals to identify like elements. A letter after a reference numeral, such as “110a,” indicates that the text refers specifically to the element having that particular reference numeral. A reference numeral in the text without a following letter, such as “110,” refers to any or all of the elements in the figures bearing that reference numeral. For example, “110” in the text refers to reference numerals “110a” and/or “110b” in the figures.

The environment 100 includes an online concierge system 102. The system 102 is configured to receive orders from one or more customers 104 (only one is shown for the sake of simplicity). An order specifies a list of goods (items or products) to be delivered to the customer 104. The order also specifies the location to which the goods are to be delivered, and a time window during which the goods should be delivered. In some embodiments, the order specifies one or more retailers from which the selected items should be purchased. The customer may use a customer mobile application (CMA) 106 to place the order; the CMA 106 is configured to communicate with the online concierge system 102.

The online concierge system 102 is configured to transmit orders received from customers 104 to one or more shoppers 108. A shopper 108 may be a contractor, employee, or other person (or entity) who is enabled to fulfill orders received by the online concierge system 102. The shopper 108 travels between a warehouse and a delivery location (e.g., the customer's home or office). A shopper 108 may travel by car, truck, bicycle, scooter, foot, or other mode of transportation. In some embodiments, the delivery may be partially or fully automated, e.g., using a self-driving car. The environment 100 also includes three warehouses 110a, 110b, and 110c (only three are shown for the sake of simplicity; the environment could include hundreds of warehouses). The warehouses 110 may be physical retailers, such as grocery stores, discount stores, department stores, etc., or non-public warehouses storing items that can be collected and delivered to customers. Each shopper 108 fulfills an order received from the online concierge system 102 at one or more warehouses 110, delivers the order to the customer 104, or performs both fulfillment and delivery. In one embodiment, shoppers 108 make use of a shopper mobile application 112 which is configured to interact with the online concierge system 102.

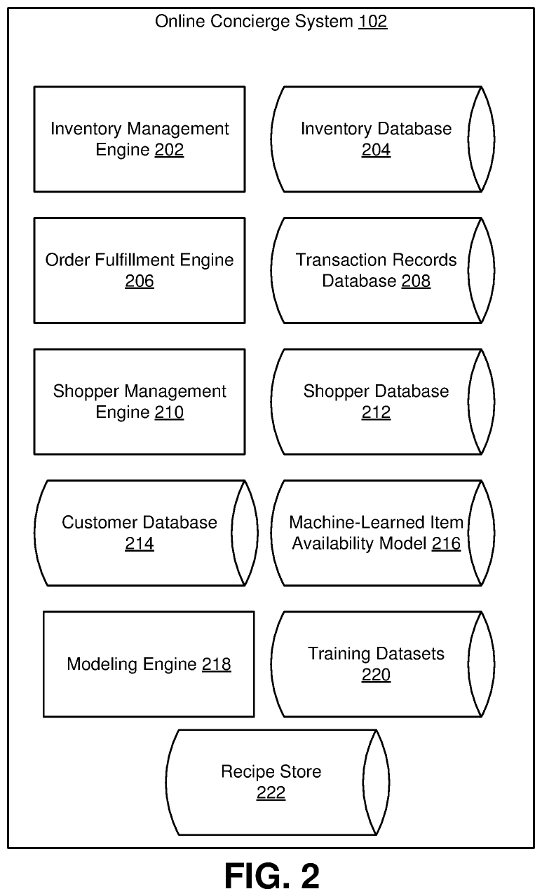

FIG. 2 is a diagram of an online concierge system 102, according to one embodiment. The online concierge system 102 includes an inventory management engine 202, which interacts with inventory systems associated with each warehouse 110. In one embodiment, the inventory management engine 202 requests and receives inventory information maintained by the warehouse 110. The inventory of each warehouse 110 is unique and may change over time. The inventory management engine 202 monitors changes in inventory for each participating warehouse 110. The inventory management engine 202 is also configured to store inventory records in an inventory database 204. The inventory database 204 may store information in separate records—one for each participating warehouse 110—or may consolidate or combine inventory information into a unified record. Inventory information includes both qualitative and qualitative information about items, including size, color, weight, SKU, serial number, and so on. In one embodiment, the inventory database 204 also stores purchasing rules associated with each item, if they exist. For example, age-restricted items such as alcohol and tobacco are flagged accordingly in the inventory database 204. Additional inventory information useful for predicting the availability of items may also be stored in the inventory database 204. For example, for each item-warehouse combination (a particular item at a particular warehouse), the inventory database 204 may store a time that the item was last found, a time that the item was last not found (a shopper looked for the item but could not find it), the rate at which the item is found, and the popularity of the item.

Inventory information provided by the inventory management engine 202 may supplement the training datasets 220. Inventory information provided by the inventory management engine 202 may not necessarily include information about the outcome of picking a delivery order associated with the item, whereas the data within the training datasets 220 is structured to include an outcome of picking a delivery order (e.g., if the item in an order was picked or not picked).

The online concierge system 102 also includes an order fulfillment engine 206 which is configured to synthesize and display an ordering interface to each customer 104 (for example, via the customer mobile application 106). The order fulfillment engine 206 is also configured to access the inventory database 204 in order to determine which products are available at which warehouse 110. The order fulfillment engine 206 may supplement the product availability information from the inventory database 204 with an item availability predicted by the machine-learned item availability model 216. The order fulfillment engine 206 determines a sale price for each item ordered by a customer 104. Prices set by the order fulfillment engine 206 may or may not be identical to in-store prices determined by retailers (which is the price that customers 104 and shoppers 108 would pay at the retail warehouses). The order fulfillment engine 206 also facilitates transactions associated with each order. In one embodiment, the order fulfillment engine 206 charges a payment instrument associated with a customer 104 when he/she places an order. The order fulfillment engine 206 may transmit payment information to an external payment gateway or payment processor. The order fulfillment engine 206 stores payment and transactional information associated with each order in a transaction records database 208.

In some embodiments, the order fulfillment engine 206 also shares order details with warehouses 110. For example, after successful fulfillment of an order, the order fulfillment engine 206 may transmit a summary of the order to the appropriate warehouses 110. The summary may indicate the items purchased, the total value of the items, and in some cases, an identity of the shopper 108 and customer 104 associated with the transaction. In one embodiment, the order fulfillment engine 206 pushes transaction and/or order details asynchronously to retailer systems. This may be accomplished via use of webhooks, which enable programmatic or system-driven transmission of information between web applications. In another embodiment, retailer systems may be configured to periodically poll the order fulfillment engine 206, which provides detail of all orders which have been processed since the last request.

The order fulfillment engine 206 may interact with a shopper management engine 210, which manages communication with and utilization of shoppers 108. In one embodiment, the shopper management engine 210 receives a new order from the order fulfillment engine 206. The shopper management engine 210 identifies the appropriate warehouse to fulfill the order based on one or more parameters, such as a probability of item availability determined by a machine-learned item availability model 216, the contents of the order, the inventory of the warehouses, and the proximity to the delivery location. The shopper management engine 210 then identifies one or more appropriate shoppers 108 to fulfill the order based on one or more parameters, such as the shoppers' proximity to the appropriate warehouse 110 (and/or to the customer 104), his/her familiarity level with that particular warehouse 110, and so on. Additionally, the shopper management engine 210 accesses a shopper database 212 which stores information describing each shopper 108, such as his/her name, gender, rating, previous shopping history, and so on.

As part of fulfilling an order, the order fulfillment engine 206 and/or shopper management engine 210 may access a customer database 214 which stores information describing each customer. This information could include each customer's name, address, gender, shopping preferences, favorite items, stored payment instruments, and so on.

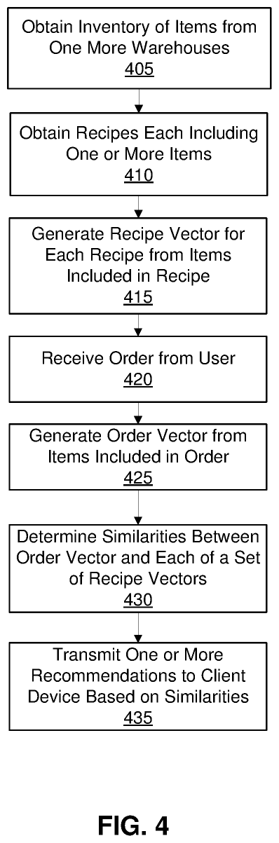

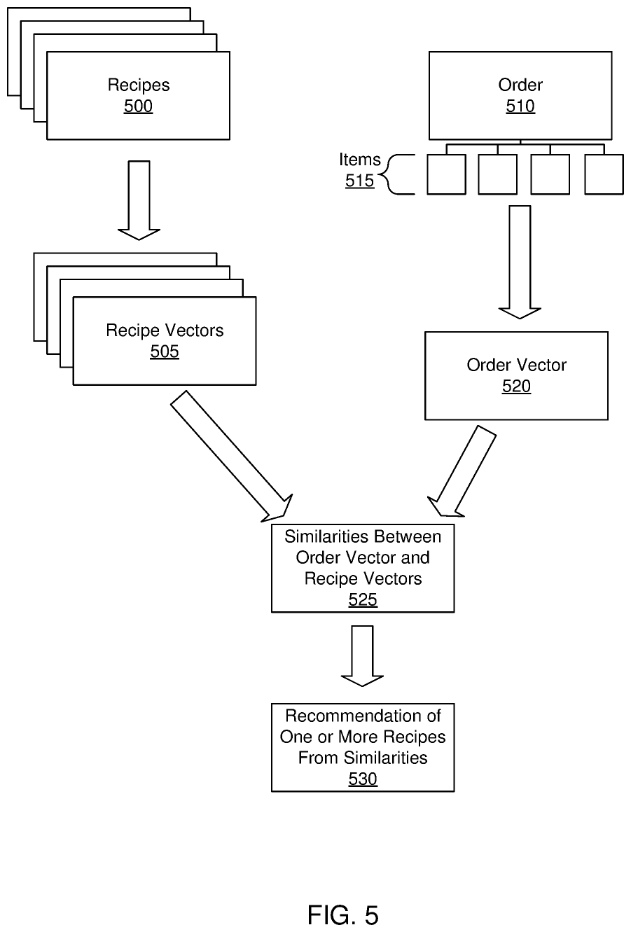

In some embodiments, the order fulfillment engine 206 generates one or more recommendations to a user from whom an order is received based on items included in the order. As further described below in conjunction with FIGS. 4 and 5, the order fulfillment engine 206 generates an order vector for a received order based on items included in the order, so different dimensions of the order correspond to different items included in the order. The order fulfillment engine 206 determines similarities between the order vector and recipe vectors corresponding to recipes obtained by the online concierge system 102. Recipe vectors are further described below in conjunction with FIG. 4. A similarity between the order vector and the recipe vector is based on an amount of items included in both the order vector and the recipe vector; hence, the similarity provides a measure of overlap between items in the order and items in the recipe corresponding to the recipe vector. Based on the similarities, the order fulfillment engine 206 selects one or more recipes and transmits a notification identifying a selected recipe to a client device for display to the user, as further described below in conjunction with FIGS. 4 and 5.

### Machine Learning Model

The online concierge system 102 further includes a machine-learned item availability model 216, a modeling engine 218, and training datasets 220. The modeling engine 218 uses the training datasets 220 to generate the machine-learned item availability model 216. The machine-learned item availability model 216 can learn from the training datasets 220, rather than follow only explicitly programmed instructions. The inventory management engine 202, order fulfillment engine 206, and/or shopper management engine 210 can use the machine-learned item availability model 216 to determine a probability that an item is available at a warehouse 110. The machine-learned item availability model 216 may be used to predict item availability for items being displayed to or selected by a customer or included in received delivery orders. A single machine-learned item availability model 216 is used to predict the availability of any number of items.

The machine-learned item availability model 216 can be configured to receive as inputs information about an item, the warehouse for picking the item, and the time for picking the item. The machine-learned item availability model 216 may be adapted to receive any information that the modeling engine 218 identifies as indicators of item availability. At minimum, the machine-learned item availability model 216 receives information about an item-warehouse pair, such as an item in a delivery order and a warehouse at which the order could be fulfilled. Items stored in the inventory database 204 may be identified by item identifiers. As described above, various characteristics, some of which are specific to the warehouse (e.g., a time that the item was last found in the warehouse, a time that the item was last not found in the warehouse, the rate at which the item is found, the popularity of the item) may be stored for each item in the inventory database 204. Similarly, each warehouse may be identified by a warehouse identifier and stored in a warehouse database along with information about the warehouse. A particular item at a particular warehouse may be identified using an item identifier and a warehouse identifier. In other embodiments, the item identifier refers to a particular item at a particular warehouse, so that the same item at two different warehouses is associated with two different identifiers. For convenience, both of these options to identify an item at a warehouse are referred to herein as an “item-warehouse pair.” Based on the identifier(s), the online concierge system 102 can extract information about the item and/or warehouse from the inventory database 204 and/or warehouse database and provide this extracted information as inputs to the item availability model 216.

The machine-learned item availability model 216 contains a set of functions generated by the modeling engine 218 from the training datasets 220 that relate the item, warehouse, and timing information, and/or any other relevant inputs, to the probability that the item is available at a warehouse. Thus, for a given item-warehouse pair, the machine-learned item availability model 216 outputs a probability that the item is available at the warehouse. The machine-learned item availability model 216 constructs the relationship between the input item-warehouse pair, timing, and/or any other inputs and the availability probability (also referred to as “availability”) that is generic enough to apply to any number of different item-warehouse pairs. In some embodiments, the probability output by the machine-learned item availability model 216 includes a confidence score. The confidence score may be the error or uncertainty score of the output availability probability and may be calculated using any standard statistical error measurement. In some examples, the confidence score is based in part on whether the item-warehouse pair availability prediction was accurate for previous delivery orders (e.g., if the item was predicted to be available at the warehouse and not found by the shopper, or predicted to be unavailable but found by the shopper). In some examples, the confidence score is based in part on the age of the data for the item, e.g., if availability information has been received within the past hour, or the past day. The set of functions of the item availability model 216 may be updated and adapted following retraining with new training datasets 220. The machine-learned item availability model 216 may be any machine learning model, such as a neural network, boosted tree, gradient boosted tree or random forest model. In some examples, the machine-learned item availability model 216 is generated from XGBoost algorithm.

The item probability generated by the machine-learned item availability model 216 may be used to determine instructions delivered to the customer 104 and/or shopper 108, as described in further detail below.

The training datasets 220 relate a variety of different factors to known item availabilities from the outcomes of previous delivery orders (e.g. if an item was previously found or previously unavailable). The training datasets 220 include the items included in previous delivery orders, whether the items in the previous delivery orders were picked, warehouses associated with the previous delivery orders, and a variety of characteristics associated with each of the items (which may be obtained from the inventory database 204). Each piece of data in the training datasets 220 includes the outcome of a previous delivery order (e.g., if the item was picked or not). The item characteristics may be determined by the machine-learned item availability model 216 to be statistically significant factors predictive of the item's availability. For different items, the item characteristics that are predictors of availability may be different. For example, an item type factor might be the best predictor of availability for dairy items, whereas a time of day may be the best predictive factor of availability for vegetables. For each item, the machine-learned item availability model 216 may weight these factors differently, where the weights are a result of a “learning” or training process on the training datasets 220. The training datasets 220 are very large datasets taken across a wide cross section of warehouses, shoppers, items, warehouses, delivery orders, times and item characteristics. The training datasets 220 are large enough to provide a mapping from an item in an order to a probability that the item is available at a warehouse. In addition to previous delivery orders, the training datasets 220 may be supplemented by inventory information provided by the inventory management engine 202. In some examples, the training datasets 220 are historic delivery order information used to train the machine-learned item availability model 216, whereas the inventory information stored in the inventory database 204 include factors input into the machine-learned item availability model 216 to determine an item availability for an item in a newly received delivery order. In some examples, the modeling engine 218 may evaluate the training datasets 220 to compare a single item's availability across multiple warehouses to determine if an item is chronically unavailable. This may indicate that an item is no longer manufactured. The modeling engine 218 may query a warehouse 110 through the inventory management engine 202 for updated item information on these identified items.

Additionally, the modeling engine 218 generates recipe vectors for recipes obtained by the online concierge system 102. In various embodiments, the modeling engine 218 identifies each item included in the recipe, so a dimension of the recipe vector corresponds to an item included in the recipe. The recipe vector may also include an importance score for each item included in the recipe, so each dimension of the recipe vector identifies an item included in the item and the importance score for the item. The importance score for an item is a term frequency-inverse document frequency (TF-IDF) value for the item in various embodiments. For example, the modeling engine 218 determines a product of a term frequency of the item in a recipe and an inverse document frequency of the term across a set of recipes. In some embodiments, the set of recipes comprises all recipes obtained by the online concierge system 102. Higher importance scores indicate an item has higher relevance to a recipe, while lower importance scores indicate the item has a lower relevance to the recipe.

The recipe store 222 includes information identifying recipes obtained by the online concierge system 102. A recipe includes one or more items, such as a plurality of items, a quantity of each item, and may also include information describing how to combine the items in the recipe. Recipes may be obtained from users, third party systems (e.g., websites, applications), or any other suitable source and stored in the recipe store 222. Additionally, each recipe has one or more attributes describing the recipe. Example attributes of a recipe include an amount of time to prepare the recipe, a complexity of the recipe, nutritional information about the recipe, a genre of the recipe, or any other suitable information. Attributes of a recipe may be included in the recipe by a source from which the recipe was received or may be determined by the online concierge system 102 from items in the recipe or other information included in the recipe.

Additionally, the recipe store 222 maintains a recipe graph identifying connections between recipes in the recipe store 222. A connection between a recipe and another recipe indicates that the connected recipes each have one or more common attributes. In some embodiments, a connection between a recipe and another recipe indicates that a user included items from each connected recipe in a common order or included items from each connected recipe in orders the online concierge system received from the user within a threshold amount of time from each other. In various embodiments, each connection between recipes includes a value, with the value providing an indication of a strength of a connection between the recipes.

### Machine Learning Factors

The training datasets 220 include a time associated with previous delivery orders. In some embodiments, the training datasets 220 include a time of day at which each previous delivery order was placed. Time of day may impact item availability, since during high-volume shopping times, items may become unavailable that are otherwise regularly stocked by warehouses. In addition, availability may be affected by restocking schedules, e.g., if a warehouse mainly restocks at night, item availability at the warehouse will tend to decrease over the course of the day. Additionally, or alternatively, the training datasets 220 include a day of the week previous delivery orders were placed. The day of the week may impact item availability, since popular shopping days may have reduced inventory of items or restocking shipments may be received on particular days. In some embodiments, training datasets 220 include a time interval since an item was previously picked in a previously delivery order. If an item has recently been picked at a warehouse, this may increase the probability that it is still available. If there has been a long time interval since an item has been picked, this may indicate that the probability that it is available for subsequent orders is low or uncertain. In some embodiments, training datasets 220 include a time interval since an item was not found in a previous delivery order. If there has been a short time interval since an item was not found, this may indicate that there is a low probability that the item is available in subsequent delivery orders. And conversely, if there is has been a long time interval since an item was not found, this may indicate that the item may have been restocked and is available for subsequent delivery orders. In some examples, training datasets 220 may also include a rate at which an item is typically found by a shopper at a warehouse, a number of days since inventory information about the item was last received from the inventory management engine 202, a number of times an item was not found in a previous week, or any number of additional rate or time information. The relationships between this time information and item availability are determined by the modeling engine 218 training a machine learning model with the training datasets 220, producing the machine-learned item availability model 216.

The training datasets 220 include item characteristics. In some examples, the item characteristics include a department associated with the item. For example, if the item is yogurt, it is associated with the dairy department. The department may be the bakery, beverage, nonfood and pharmacy, produce and floral, deli, prepared foods, meat, seafood, dairy, the meat department, or dairy department, or any other categorization of items used by the warehouse. The department associated with an item may affect item availability, since different departments have different item turnover rates and inventory levels. In some examples, the item characteristics include an aisle of the warehouse associated with the item. The aisle of the warehouse may affect item availability, since different aisles of a warehouse may be more frequently re-stocked than others. Additionally, or alternatively, the item characteristics include an item popularity score. The item popularity score for an item may be proportional to the number of delivery orders received that include the item. An alternative or additional item popularity score may be provided by a retailer through the inventory management engine 202. In some examples, the item characteristics include a product type associated with the item. For example, if the item is a particular brand of a product, then the product type will be a generic description of the product type, such as “milk” or “eggs.” The product type may affect the item availability, since certain product types may have a higher turnover and re-stocking rate than others, or may have larger inventories in the warehouses. In some examples, the item characteristics may include a number of times a shopper was instructed to keep looking for the item after he or she was initially unable to find the item, a total number of delivery orders received for the item, whether or not the product is organic, vegan, gluten free, or any other characteristics associated with an item. The relationships between item characteristics and item availability are determined by the modeling engine 218 training a machine learning model with the training datasets 220, producing the machine-learned item availability model 216.

The training datasets 220 may include additional item characteristics that affect the item availability, and can therefore be used to build the machine-learned item availability model 216 relating the delivery order for an item to its predicted availability. The training datasets 220 may be periodically updated with recent previous delivery orders. The training datasets 220 may be updated with item availability information provided directly from shoppers 108. Following updating of the training datasets 220, a modeling engine 218 may retrain a model with the updated training datasets 220 and produce a new machine-learned item availability model 216.

### Customer Mobile Application

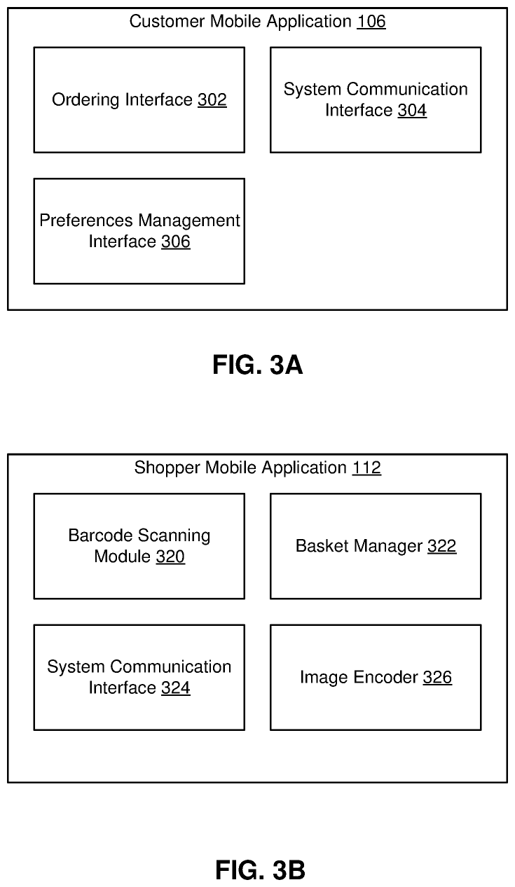

FIG. 3A is a diagram of the customer mobile application (CMA) 106, according to one embodiment. The CMA 106 includes an ordering interface 302, which provides an interactive interface with which the customer 104 can browse through and select products and place an order. The CMA 106 also includes a system communication interface 304 which, among other functions, receives inventory information from the online shopping concierge system 102 and transmits order information to the system 102. The CMA 106 also includes a preferences management interface 306 which allows the customer 104 to manage basic information associated with his/her account, such as his/her home address and payment instruments. The preferences management interface 306 may also allow the customer to manage other details such as his/her favorite or preferred warehouses 110, preferred delivery times, special instructions for delivery, and so on.

### Shopper Mobile Application

FIG. 3B is a diagram of the shopper mobile application (SMA) 112, according to one embodiment. The SMA 112 includes a barcode scanning module 320 which allows a shopper 108 to scan an item at a warehouse 110 (such as a can of soup on the shelf at a grocery store). The barcode scanning module 320 may also include an interface which allows the shopper 108 to manually enter information describing an item (such as its serial number, SKU, quantity and/or weight) if a barcode is not available to be scanned. SMA 112 also includes a basket manager 322 which maintains a running record of items collected by the shopper 108 for purchase at a warehouse 110. This running record of items is commonly known as a “basket”. In one embodiment, the barcode scanning module 320 transmits information describing each item (such as its cost, quantity, weight, etc.) to the basket manager 322, which updates its basket accordingly. The SMA 112 also includes a system communication interface 324 which interacts with the online shopping concierge system 102. For example, the system communication interface 324 receives an order from the system 102 and transmits the contents of a basket of items to the system 102. The SMA 112 also includes an image encoder 326 which encodes the contents of a basket into an image. For example, the image encoder 326 may encode a basket of goods (with an identification of each item) into a QR code which can then be scanned by an employee of the warehouse 110 at check-out.

### Selecting One or More Recipes for Display a User

FIG. 4 is a flowchart of one embodiment of a method for selecting one or more recipes for a user of an online concierge system 102. In various embodiments, the method includes different or additional steps than those described in conjunction with FIG. 4. Further, in some embodiments, the steps of the method may be performed in different orders than the order described in conjunction with FIG. 4. The method described in conjunction with FIG. 4 may be carried out by the online concierge system 102 in various embodiments.

The online concierge system 102 obtains 405 an inventory of items offered by one or more warehouses 110. In some embodiments, the online concierge system 102 obtains 405 an inventory from each warehouse 110, with an inventory from a warehouse identifying items offered by the warehouse 110. The inventory includes different entries, with each entry including information identifying an item (e.g., an item identifier, an item name) and one or more attributes of the item. Example attributes of an item include: one or more keywords, a brand offering the item, a manufacturer of the item, a type of the item, a price of the item, a quantity of the item, a size of the item and any other suitable information. Additionally, one or more attributes of an item may be specified by the online concierge system 102 for the item and included in the entry for the item in the inventory. Example attributes specified by the online concierge system 102 for an item include: a category for the item, one or more sub-categories for the item, and any other suitable information for the item.

Additionally, the online concierge system 102 obtains 410 recipes from one or more sources. Example sources include a warehouse 110 or a third party system (e.g., a website) exchanging information with the online concierge system 102. Each recipe includes one or more items, or a plurality of items. A recipe may include a quantity corresponding to each item included in the recipe. Additionally, a recipe may include instructions for combining items included in the recipe. In various embodiments, a recipe includes a title, a description, identifiers of one or more items, and quantities for each of the one or more items included in the recipe.

For each recipe, the online concierge system 102 generates 415 a recipe vector. To generate 420 the recipe vector for a recipe, the online concierge system 102 identifies each item included in the recipe, so a dimension of the recipe vector corresponds to an item included in the recipe. Hence, different dimensions of a recipe vector correspond to different items included in the recipe.

In various embodiments, the recipe vector also includes an importance score for each item included in the recipe, so each dimension of the recipe vector identifies an item included in the item and the importance score for the item. The importance score for an item is a term frequency-inverse document frequency (TF-IDF) value for the item in various embodiments. In an embodiment, the online concierge system 102 determines a product of a term frequency of the item in a recipe and an inverse document frequency of the term across a set of recipes. However, the importance score may be determined based on any suitable method or methods for determining an importance of a term to a document; for example, the importance score is determined from any suitable measure of a frequency of a term occurring in a recipe relative to a frequency of the term occurring across a set of recipes. In some embodiments, the set of recipes comprises all recipes obtained 410 by the online concierge system 102. Higher importance scores indicate an item has higher relevance to a recipe, while lower importance scores indicate the item has a lower relevance to the recipe. In various embodiments, the online concierge system 102 normalizes the importance scores for items so an importance score has a value between 0 and 1.

In some embodiments, the online concierge system 102 uses recipe vectors for different recipes to determine similarities between different recipes. The similarity between a pair of recipes is based on an amount of items common to each recipe. For example, the similarity between a recipe and an additional recipe is a ratio of items included in both the recipe and the additional recipe to a total number of items included in the recipe and the additional recipe. Hence, the similarity between a recipe and additional recipe is a Jaccard similarity between the recipe vector for the recipe and the additional recipe vector for the additional recipe. In some embodiments, when determining the similarity between a recipe and an additional recipe, the online concierge system 102 accounts for importance scores of items included in the recipe and included in the additional recipe. For example, the similarity between the recipe and the additional recipe is a weighted Jaccard similarity that sums importance scores for items in the recipe and in the additional recipe. As an example, for items included in both the recipe and in the additional recipe, the online concierge system 102 selects a minimum of the importance score of an item to the recipe and the importance score of the item to the additional recipe and sums the selected importance scores for the items included in both the recipe and in the additional recipe. Similarly, the online concierge system 102 selects a maximum importance score of items to the recipe and to the additional recipe and sums the maximum importance score of items included in the recipe or included in the additional recipe. The online concierge system 102 determines the similarity of the recipe to the additional recipe by dividing the sum of the selected importance scores for the items included in both tie recipe and the additional recipe by the sum of the maximum importance scores for each item to one of the recipe or to the additional recipe. A higher similarity between a recipe and an additional recipe indicates the recipe and the additional recipe have a larger number of common items, while lower similarity between the recipe and the additional recipe indicates the recipe and the additional recipe have fewer common items.

In other embodiments, the similarity between a recipe and an additional recipe is based on a distance between the recipe and the additional recipe, with smaller distances between a recipe vector of the recipe and an additional recipe of the additional recipe indicating a higher similarity between the recipe and the additional recipe. The online concierge system 102 may determine the distance between a recipe vector and an additional recipe vector using any suitable method, such as cosine similarity, Euclidean distance, or any other suitable method. Hence, the similarity between a pair of recipes may be based on a distance between recipe vectors corresponding to each of the recipes in various embodiments.

In various embodiments, the online concierge system 102 uses similarities between recipes to recommend one or more additional recipes to a user. For example, the user selects a recipe from the online concierge system 102 to view on a client device, such as through a customer mobile application 106 executing on the client device. The online concierge system 102 retrieves a recipe vector for the selected recipe and determines similarities between the recipe vector for the selected recipe and recipe vectors for each recipe of a set. Based on the determined similarities, the online concierge system 102 identifies one or more recipes of the set and displays information describing the identified one or more recipes to the user via the client device. For example, the online concierge system 102 identifies recipes of the set having recipe vectors with at least a threshold similarity to the recipe vector of the selected recipe. As another example, the online concierge system 102 ranks recipes of the set based on their similarities to the recipe vector of the selected recipe and identifies recipes of the set having at least a threshold position in the ranking.

When the online concierge system 102 receives 420 an order from a user, the online concierge system 102 receives selections of items for inclusion in the order from the user. The online concierge system 102 generates 425 an order vector for the order based on items included in the order. In various embodiments, the order vector includes different dimensions that each correspond to a different item included in the order. In some embodiments, when generating 425 the order vector, the online concierge system 102 retrieves one or more prior orders received from the user and generates 425 the order vector based on items included in the received order and included in the one or more prior orders, allowing the online concierge system 102 to account for items the user has previously purchased via the online concierge system 102 when generating 425 the order vector. In some embodiments, the online concierge system 102 retrieves prior orders received within a threshold amount of time from a time when the order 420 was received, and generates 425 the order vector based on items included in the received order and included in the one or more prior orders; hence, the order vector includes different dimensions each corresponding to an item included in the received order or included in one or more of the retrieved prior orders.

The online concierge system 102 determines 430 similarities between the order vector and each of a set of recipe vectors. The similarity between the order vector and a recipe vector is based on an amount of items common to each recipe. For example, the similarity between the order vector and a recipe vector is a ratio of items included in both the order vector and in the recipe vector to a total number of items included in the order vector and included in the recipe vector. Hence, the similarity is a Jaccard similarity between the order vector and the recipe vector in some embodiments. Alternatively, the similarity between the order vector and the recipe vector is a percentage of items included in the recipe vector that are included in the order vector. However, in other embodiments, the online concierge system 102 determines 430 a similarity between an order vector and a recipe vector using any suitable metric. In various embodiments, a higher similarity between the order vector and the recipe vector corresponds to a greater amount of items included in the recipe vector that are included in the order vector. The similarity accounts for measures of importance of items in the recipe vector in various embodiments. For example, the similarity weights items included in the recipe vector that are included in the order vector by their corresponding importance scores and determines 430 the similarity of the recipe vector to the order vector by combining the weighted items included in the recipe vector; hence, items with higher importance values in a recipe vector being included in the order vector increase the similarity of the order vector to the recipe vector.

In some embodiments, when determining 430 similarity between the order vector and a recipe vector, the online concierge system 102 accounts for a quantity of an item included in the order and a quantity of the item specified by a recipe corresponding to the recipe vector. For a specific item included in a recipe, the online concierge system 102 retrieves a quantity of the specific item specified by the recipe. If the specific item is not included in the order received 420 from the user but was included in one or more prior orders received from the user that the online concierge system 102 retrieved, as further described above, the online concierge system 102 determines a quantity of the specific item included in one or more prior orders from the user retrieved by the online concierge system 102. From one or more characteristics of the specific item, a timing of the prior order from the user including the specific item, a timing of the received order, and the quantity of the specific item included in the prior order, the online concierge system 102 generates a prediction of the remaining quantity of the specific item equaling or exceeding the quantity of the specific item specified by the recipe. In various embodiments, the online concierge system 102 trains a model to estimate a number of the specific item remaining at a time when the order was received 420 from historical orders including the specific item received from the user and times when the historical orders including the specific item were received from the user. The online concierge system 102 may train the model using any suitable method or combination of methods to train the model from training data comprising historical orders including the specific item received from the user, characteristics of the specific item, characteristics of the user, and timing of the historical orders including the specific item labeled with an indication of whether a historical order included the specific item. The online concierge system 102 applies the model to labeled examples from the training data and trains the model using any suitable training method. Subsequently the online concierge system 102 applies the trained model to a prior order including the specific item, characteristics of the user, and characteristics of the specific item to generate a prediction of a remaining quantity of the specific item when the order was received 420 from the user. The online concierge system 120 compares the prediction of the remaining quantity of the specific item to the quantity of the specific item included in the recipe. In response to the prediction of the remaining quantity of the specific item being less than the quantity of the specific item included in the recipe, the online concierge system 102 removes the specific item from the order vector and determines 430 similarity between the order vector with the specific item removed and a recipe vector. This allows the online concierge system 102 to account for the user's consumption of the specific item included in a prior order over time when determining similarity between items included in an order vector and items included in a recipe.

Based on the similarities between the order vector and each of the set of recipe vectors, the online concierge system 102 transmits 435 one or more recommendations to a client device of the user for display. In various embodiments, the recommendations are displayed through a customer mobile application 106 displayed to the user via a client device 102. For example, the online concierge system 102 ranks recipe vectors based on their similarities to the order vector and selects recipes having at least a threshold position in the ranking or selects a recipe having a highest position in the ranking. A recommendation transmitted 435 to the client device 102 of the user includes an identifier of a selected recipe, such as a name of the selected recipe. In some embodiments, the recommendation also identifies one or more items included in the selected recipe that are not included in the received order and were not included in the one or more prior orders retrieved by the online concierge system 102. Hence, a recommendation may include a name or a description of a selected recipe and a name or a description of one or more items included in the selected recipe that are not included in the order vector form the received order and the one or more prior orders retrieved by the online concierge system 102. In some embodiments, the recommendation includes an interface element that, when selected by the user, includes items included in the selected recipe that are not included in the order vector from the received order and the one or more prior orders retrieved by the online concierge system 102, streamlining completion of the received order to include items for the selected recipe.

FIG. 5 is a process flow diagram of one embodiment of a method for selecting one or more recipes for a user of an online concierge system 102. The online concierge system 102 obtains various recipes 500 from one or more sources. Each recipe 500 includes one or more items, instructions for combining the items, and quantities of each item. For each recipe 500, the online concierge system 102 generates a recipe vector 505. As further described above in conjunction with FIG. 4, a recipe vector 505 for a recipe includes different dimensions corresponding to different items included in the recipe 500. Additionally, in various embodiments, each dimension of a recipe vector 505 also includes an importance score of the item to the recipe 500, so a dimension includes a name or other identifier of the item and an importance score of the item. Determination of the importance score of an item to a recipe 500 is further described above in conjunction with FIG. 4.

Additionally, the online concierge system 102 receives an order 510 from a user. The order 510 includes one or more items 515 selected by the user. From the items 515 included in the order, the online concierge system 102 generates an order vector 520 describing the order. Similar to a recipe vector 505, the order vector 520 includes multiple dimensions, with each dimension corresponding to an item 515 included in the order.

To simplify inclusion of additional items in the order 510, the online concierge system 102 determines similarities 525 between the order vector 520 and each of a set of recipe vectors 505. As further described above in conjunction with FIG. 4, a similarity 525 between the order vector 520 and a recipe vector 505 is based on a number of items included in both the recipe vector 505 and in the order vector 520. In some embodiments, the similarity 525 accounts for an importance score of an item in the recipe vector 505, increasing the similarity 525 of the order vector 520 for a recipe vector 505 when items with larger importance scores in the recipe vector 505 are also included in the order vector 520. As further described above in conjunction with FIG. 4, the order vector 520 may include dimensions for items included in one or more prior orders previously received from the user, such are prior orders received within a threshold amount of time from a time when the online concierge system 102 received the order 510.

From the similarities 525, the online concierge system 102 selects one or more recipes and generates a recommendation 530 identifying the one or more selected recipes. For examples, the online concierge system 102 selects recipes corresponding to recipe vectors 505 having at least a threshold position in a ranking based on the similarities 525. In some embodiments, the recommendation 530 identifies a selected recipe and identifies one or more items included in a recipe vector 505 for the selected recipe that are not included in the order vector 520, allowing the user to more readily identify items to add to the order to complete the selected recipe.

### Additional Considerations

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a tangible computer readable storage medium, which include any type of tangible media suitable for storing electronic instructions and coupled to a computer system bus. Furthermore, any computing systems referred to in the specification may include a single processor or may be architectures employing multiple processor designs for increased computing capability.

Embodiments of the invention may also relate to a computer data signal embodied in a carrier wave, where the computer data signal includes any embodiment of a computer program product or other data combination described herein. The computer data signal is a product that is presented in a tangible medium or carrier wave and modulated or otherwise encoded in the carrier wave, which is tangible, and transmitted according to any suitable transmission method.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A method comprising:
obtaining, at an online concierge system, a plurality of recipes, each recipe including one or more items offered by one or more warehouses and instructions for combining the items included in the recipe;
generating a recipe vector for each of the plurality of recipes, the recipe vector for a recipe including different dimensions for different items included in the recipe;
receiving an order from a user of the online concierge system, the order including one or more items selected by the user;
generating an order vector for the order, the order vector including different dimensions for different items included in the order;
determining a similarity between the order vector and recipe vectors for each of a set of recipes;
selecting a recipe based on the determined similarities; and
transmitting a recommendation identifying the selected recipe to a client device of the user for display.

2. The method of claim 1, wherein the similarity between the order vector and a recipe vector for a recipe of the set is based on a number of items included in the order vector and included in the recipe vector for a recipe of the set.

3. The method of claim 2, wherein the recommendation identifies the selected recipe and identifies one or more items included in the recipe vector for the selected recipe and not included in the order vector.

4. The method of claim 1, wherein generating the order vector for the order comprises:
retrieving one or more prior orders the online concierge system previously received from the user; and
generating the order vector from items included in the order and included in the retrieved one or more prior orders, so each dimension of the order vector corresponds to an item included in the received order or an item included in a retrieved prior order.

5. The method of claim 4, wherein the one or more prior orders comprise prior orders received by the online concierge system from the user within a threshold amount of time from a time when the online concierge system received the order from the user.

6. The method of claim 4, wherein determining the similarity between the order vector and recipe vectors for each of a set of recipes comprises:
identifying a specific item included in a recipe vector of a recipe of the set;
responsive to determining the specific item is not included in the received order, retrieving a quantity of the specific item specified by the recipe of the set;
determining a quantity of the specific item included in the one or more prior orders;
generating a predicted remaining quantity of the specific item from the quantity of the specific item included in the one or more prior orders, timing of the one or more prior orders, and characteristics of the specific item;
responsive to the predicted remaining quantity of the specific item being less than the quantity of the specific item specified from the recipe of the set, removing the specific item from the order vector; and
determining a similarity between the recipe vector of the recipe of the set and the order vector with the specific item removed.

7. The method of claim 1, wherein the recommendation further includes information describing one or more items included in a recipe vector of the selected recipe that are not included in the order vector.

8. The method of claim 1, wherein each dimension of the recipe vector for the recipe includes an identifier of an item and an importance score of the item to the recipe.

9. The method of claim 8, wherein the importance score of the item to the recipe comprises a product of a term frequency of the item in the recipe and an inverse document frequency of the term across the plurality of recipes.

10. The method of claim 8, wherein the similarity between the order vector and a recipe vector for a recipe of the set is based on a number of items included in the order vector and included in the recipe vector for a recipe of the set, with each item included in the order vector and included in the recipe vector weighted by the importance score.

11. A computer program product comprising a non-transitory computer readable storage medium having instructions encoded thereon that, when executed by a processor, cause the processor to:
obtain, at an online concierge system, a plurality of recipes, each recipe including one or more items offered by one or more warehouses and instructions for combining the items included in the recipe;
generate a recipe vector for each of the plurality of recipes, the recipe vector for a recipe including different dimensions for different items included in the recipe;
receive an order from a user of the online concierge system, the order including one or more items selected by the user;
generate an order vector for the order, the order vector including different dimensions for different items included in the order;
determine a similarity between the order vector and recipe vectors for each of a set of recipes;
select a recipe based on the determined similarities; and
transmit a recommendation identifying the selected recipe to a client device of the user for display.

12. The computer program product of claim 11, wherein the similarity between the order vector and a recipe vector for a recipe of the set is based on a number of items included in the order vector and included in the recipe vector for a recipe of the set.

13. The computer program product of claim 12, wherein the recommendation identifies the selected recipe and identifies one or more items included in the recipe vector for the selected recipe and not included in the order vector.

14. The computer program product of claim 11, wherein generate the order vector for the order comprises:
retrieve one or more prior orders the online concierge system previously received from the user; and
generate the order vector from items included in the order and included in the retrieved one or more prior orders, so each dimension of the order vector corresponds to an item included in the received order or an item included in a retrieved prior order.

15. The computer program product of claim 14, wherein the one or more prior orders comprise prior orders received by the online concierge system from the user within a threshold amount of time from a time when the online concierge system received the order from the user.

16. The computer program product of claim 14, wherein determine the similarity between the order vector and recipe vectors for each of a set of recipes comprises:
identify a specific item included in a recipe vector of a recipe of the set;
responsive to determining the specific item is not included in the received order, retrieve a quantity of the specific item specified by the recipe of the set;
determine a quantity of the specific item included in the one or more prior orders;
generate a predicted remaining quantity of the specific item from the quantity of the specific item included in the one or more prior orders, timing of the one or more prior orders, and characteristics of the specific item;
responsive to the predicted remaining quantity of the specific item being less than the quantity of the specific item specified from the recipe of the set, remove the specific item from the order vector; and
determine a similarity between the recipe vector of the recipe of the set and the order vector with the specific item removed.

17. The computer program product of claim 11, wherein the recommendation further includes information describing one or more items included in a recipe vector of the selected recipe that are not included in the order vector.

18. The computer program product of claim 11, wherein each dimension of the recipe vector for the recipe includes an identifier of an item and an importance score of the item to the recipe.

19. The computer program product of claim 18, wherein the importance score of the item to the recipe comprises a product of a term frequency of the item in the recipe and an inverse document frequency of the term across the plurality of recipes.

20. The computer program product of claim 18, wherein the similarity between the order vector and a recipe vector for a recipe of the set is based on a number of items included in the order vector and included in the recipe vector for a recipe of the set, with each item included in the order vector and included in the recipe vector weighted by the importance score.
